(19) United States
(12) Patent Application Publication
(10) Pub. No.: US 2026/0171691 A1
(43) Pub. Date: Jun. 18, 2026

(54) TERMINAL BLOCK

(71) Applicant: SUMITOMO WIRING SYSTEMS, LTD., Mie (JP)

(72) Inventor: Isao WAKIMOTO, Mie (JP)

(21) Appl. No.: 18/850,569

(22) PCT Filed: Mar. 23, 2023
(86) PCT No.: PCT/JP2023/011455

§ 371 Date: Sep. 25, 2024

(30) Foreign Application Priority Data
Mar. 30, 2022 (JP) 2022-057298

(51) Int. Cl. H01R 9/24

(52) U.S. Cl. CPC H01R 9/2416

(57) ABSTRACT

A terminal block includes a housing made of resin for holding a terminal. The housing includes a receptacle and a fitting portion constituting a tube portion, and an extending portion extending toward an outer peripheral side of the receptacle. The fitting portion constituting a part of the tube portion of the housing is fit in an opening. A water stop member is arranged between an outer peripheral surface of the fitting portion and an inner peripheral surface of the opening to stop water therebetween. The extending portion is provided over an entire periphery of the receptacle constituting the tube portion. The extending portion has larger external dimensions than the opening over an entire periphery of the opening when viewed from an opening direction of the opening with the fitting portion fit in the opening.

### TECHNICAL FIELD

The present disclosure relates to a terminal block.

### BACKGROUND

For example, Patent Document 1 discloses a terminal block to be mounted into an opening provided in an enclosure of a device. This terminal block is provided with a resin molded portion including a tubular body portion and a terminal extending from the inner peripheral surface of the body portion. With the terminal block mounted on the device enclosure, the terminal of the terminal block is connected to a device-side terminal. Further, the terminal block is provided with a water stop member interposed between the resin molded portion and a surface of the device enclosure. The water stop member suppresses water intrusion into the opening of the device enclosure. Therefore, water intrusion into the device enclosure through the opening, in which the terminal block is mounted, is suppressed by the water stop member.

### PRIOR ART DOCUMENT

### Patent Document

Patent Document 1: International Publication No. WO 2019/230468

### SUMMARY OF THE INVENTION

### Problems to be Solved

In the case of using the terminal block as described above in an environment easily exposed to water, there is a concern that the water stop member is exposed to water. If no measure is taken against the water exposure of the water stop member, there is a concern that the deterioration of the water stop member by water exposure accelerates.

The present disclosure aims to provide a terminal block capable of suppressing the water exposure of a water stop member.

### Means to Solve the Problem

Th present disclosure is directed to a terminal block to be mounted into an opening provided in an enclosure of a device, the terminal block being provided with a resin molded portion made of resin, the resin molded portion including a tube portion to be fit into the opening and an extending portion extending toward an outer peripheral side from the tube portion, a terminal projecting toward an inner peripheral side of the tube portion from an inner peripheral surface of the tube portion, a wire connected to the terminal, a water stop member arranged between an outer peripheral surface of the tube portion and an inner peripheral surface of the opening to stop water therebetween, and a first shield shell made of metal, the first shield shell covering the extending portion, the extending portion being provided over an entire periphery of the tube portion, and the extending portion having larger external dimensions than the opening over an entire periphery of the opening when viewed from an opening direction of the opening with the tube portion fit in the opening.

### Effect of the Invention

The terminal block of the present disclosure exhibits an effect of suppressing the water exposure of the water stop member.

### BRIEF DESCRIPTION OF THE DRAWINGS

FIG. 1 is a perspective view showing a terminal block of an embodiment.

FIG. 2A is a section showing the terminal block of the embodiment.

FIG. 2B is an enlarged section enlargedly showing a part of the terminal block of the embodiment.

FIG. 3 is an exploded perspective view showing the terminal block of the embodiment.

FIG. 4 is a back view showing the terminal block of the embodiment.

FIG. 5 is a diagram showing a relationship of an extending portion and an opening of an enclosure in the terminal block of the embodiment when viewed from an opening direction of the opening.

FIG. 6 is an exploded perspective view of a second shield shell in the terminal block of the embodiment.

### DETAILED DESCRIPTION TO EXECUTE THE INVENTION

### Description of Embodiments of Present Disclosure

First, embodiments of the present disclosure are listed and described.
[1] The terminal block of the present disclosure is to be mounted into an opening provided in an enclosure of a device and provided with a resin molded portion made of resin, the resin molded portion including a tube portion to be fit into the opening and an extending portion extending toward an outer peripheral side from the tube portion, a terminal projecting toward an inner peripheral side of the tube portion from an inner peripheral surface of the tube portion, a wire connected to the terminal, a water stop member arranged between an outer peripheral surface of the tube portion and an inner peripheral surface of the opening to stop water therebetween, and a first shield shell made of metal, the first shield shell covering the extending portion, the extending portion being provided over an entire periphery of the tube portion, and the extending portion having larger external dimensions than the opening over an entire periphery of the opening when viewed from an opening direction of the opening with the tube portion fit in the opening.

According to this configuration, the water stop member is arranged between the outer peripheral surface of the tube portion and the inner peripheral surface of the opening. Since the water stop member can be arranged at a deep position of the opening in this way, the water exposure of the water stop member can be suppressed. Further, the extending portion has the larger external dimensions than the opening over the entire periphery of the opening when viewed from the opening direction of the opening. In this way, water intrusion into the opening can be suitably suppressed by the extending portion. Therefore, the water exposure of the water stop member can be further suppressed by the extending portion.
[2] The extending portion includes a terminal holding portion for holding the terminal in a circumferential part, the terminal includes a terminal connecting portion projecting toward the inner peripheral side of the tube portion from the inner peripheral surface of the tube portion and an embedded portion embedded in the terminal holding portion, and the wire is connected to the embedded portion and pulled out to outside from inside of the resin molded portion.

According to this configuration, the terminal holding portion for holding the embedded portion of the terminal constitutes a part of the extending portion. That is, the water exposure of the water stop member can be suppressed by the extending portion including the terminal holding portion.
[3] A gap enabling a liquid to flow is formed between the first shield shell and the extending portion.

According to this configuration, water can be suppressed from staying between the extending portion and the first shield shell by the gap between the extending portion and the first shield shell. As a result, the water exposure of the water stop member can be more suitably suppressed.
[4] A second shield shell is provided which covers the resin molded portion and the first shield shell, the second shield shell includes a shell body made of metal, the shell body covering the resin molded portion and the first shield shell, and a closing member provided on a side of the shell body toward the resin molded portion, the closing member closing one end part of the tube portion, and gaps enabling a liquid to flow are respectively formed between the shell body and the closing member and between the shell body and the resin molded portion.

According to this configuration, since the resin molded portion is easily exposed to water, for example, when water intrudes into the inside of the terminal holding portion, a water exposure suppressing effect for the water stop member by the extending portion can be obtained more notably.

The shell body includes an inclined portion inclined to approach the resin molded portion from an end part on a rear side toward a front side when a side of the extending portion where the terminal holding portion is provided is the rear side and an opposite side thereof is the front side.
[5] According to this configuration, water adhering to the outer surface of the shell body easily flows toward the front side, i.e. the side opposite to the terminal holding portion, by the inclination of the inclined portion. In this way, it is possible to suppress the flow of the water adhering to the outer surface of the shell body toward the terminal holding portion.

### Details of Embodiment of Present Disclosure

A specific example of a terminal block of the present disclosure is described below with reference to the drawings. For the convenience of description, some components may be shown in an exaggerated or simplified manner in each drawing. Further, a dimension ratio of each part may be different in each drawing. Note that the present disclosure is not limited to these illustrations, but is represented by claims and intended to include all changes in the scope of claims and in the meaning and scope of equivalents. “Orthogonal” in this specification means not only strictly orthogonal, but also substantially orthogonal within a range in which functions and effects in this embodiment are achieved.

Note that a term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Further, the “tubular” shapes include circular shapes, elliptical shapes and polygonal shapes with angular or rounded corners.

Further, “facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts.

### (Configuration of Terminal Block 10)

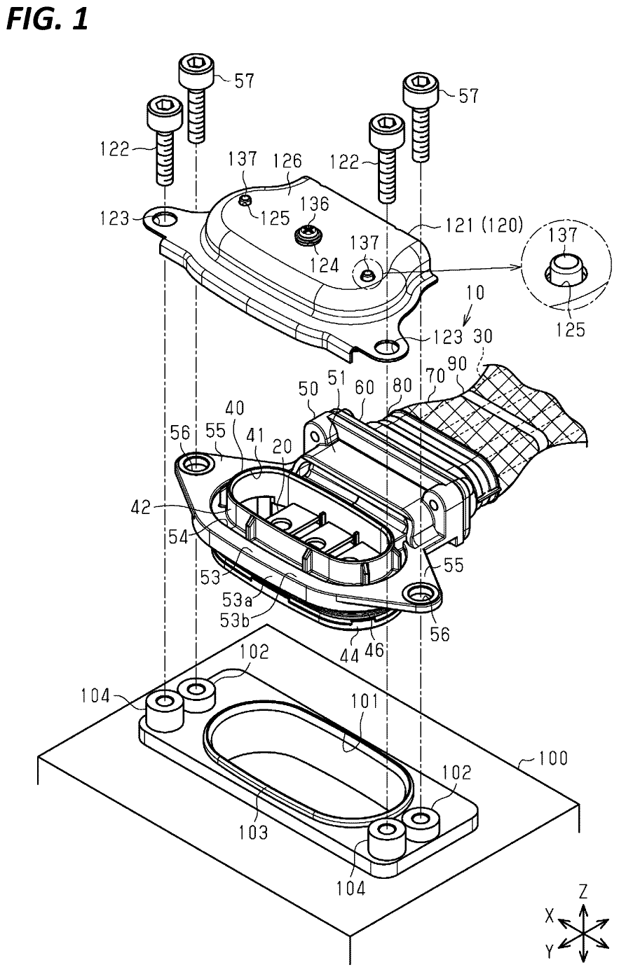

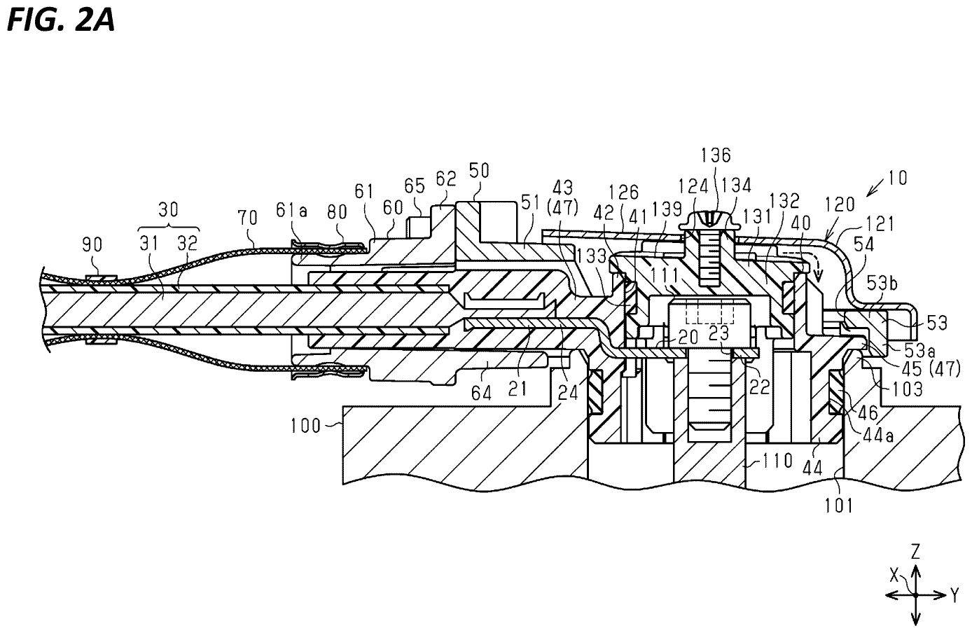

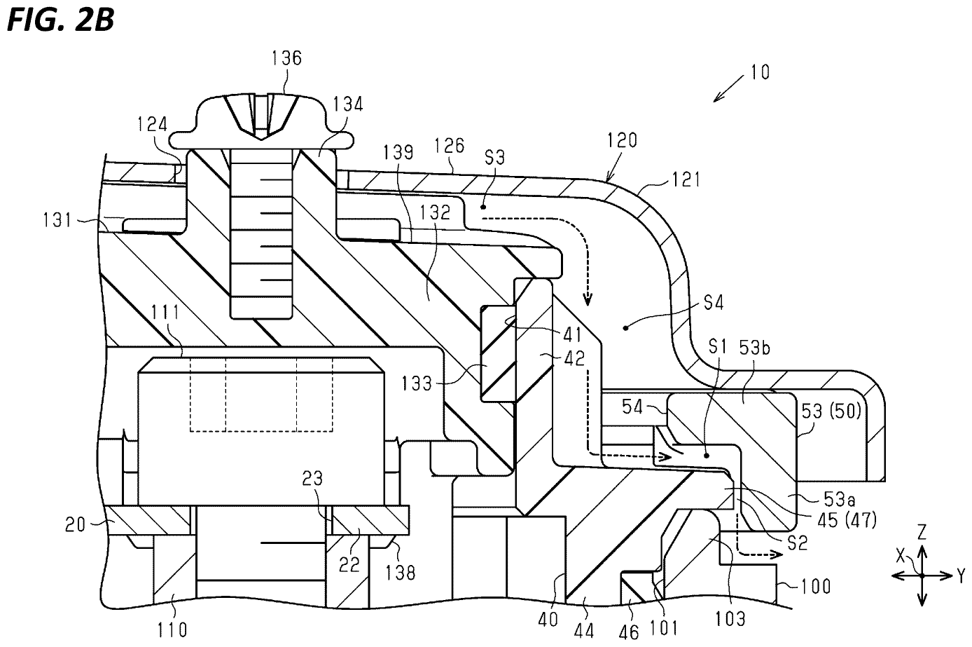

A terminal block 10 shown in FIGS. 1 and 2A is for electrically connecting devices for vehicle such as a motor and an inverter. The terminal block 10 is mounted on an enclosure 100 of a device including an opening 101. A plurality of mating terminals 110 made of metal are provided inside the enclosure 100. The device and the terminal block 10 mounted on the enclosure 100 of this device are, for example, provided in an environment easily exposed to water such as an engine compartment of a vehicle.

The terminal block 10 is provided with a plurality of terminals 20 arranged in parallel, a plurality of wires 30 to be connected to the plurality of terminals 20 and a housing 40 for holding the plurality of terminals 20 and the plurality of wires 30. The terminal block 10 is, for example, provided with three terminals 20 and three wires 30. The wires 30 are pulled out from the housing 40.

In the following description, a parallel direction of the plurality of terminals 20 is referred to as an X-axis direction, an extension direction of the wires 30 pulled out from the housing 40 is referred to as a Y-axis direction and a direction orthogonal to both the X-axis direction and the Y-axis direction is referred to as a Z-axis direction. The X-axis direction, the Y-axis direction and the Z-axis direction are orthogonal to each other.

The terminal block 10 is provided with a first shield shell 50 for covering the housing 40 and a bracket 60 to be mounted on the first shield shell 50. Further, the terminal block 10 is provided with a braided member 70 for covering the bracket 60, a crimp ring 80 for mounting the braided member 70 on the bracket 60 and a fixing member 90 for fixing the braided member 70 to the wires 30. Further, the terminal block 10 is provided with a second shield shell 120 for covering the housing 40 and the first shield shell 50.

### (Configuration of Terminal 20)

As shown in FIG. 2A, the terminal 20 includes a wire connecting portion 21 and a terminal connecting portion 22. The terminal 20 is a single component in which the wire connecting portion 21 and the terminal connecting portion 22 are integrally formed. A copper-based or aluminum-based metal material or the like can be, for example, used as a material of the terminal 20.

The wire 30 is electrically connected to the wire connecting portion 21. The wire connecting portion 21 is, for example, connected to the wire 30 by crimping.

The terminal connecting portion 22 is, for example, plate-like. The terminal connecting portion 22 extends in the Y-axis direction from the wire connecting portion 21. The terminal connecting portion 22 is provided with an insertion hole 23, into which a bolt 111 inserted. The insertion hole 23 penetrates through the terminal connecting portion 22 in the Z-axis direction. Each terminal connecting portion 22 is electrically connected to each mating terminal 110 provided inside the enclosure 100 by the bolt 111 inserted into the insertion hole 23.

### (Configuration of Wire 30)

The wire 30 includes a core wire 31 and an insulation coating 32 covering the outer periphery of the core wire 31. The core wire 31 is exposed form the insulation coating 32 in an end part of the wire 30. The core wire 31 exposed from the insulation coating 32 is connected to the wire connecting portion 21 of the terminal 20.

### (Configuration of Housing 40)

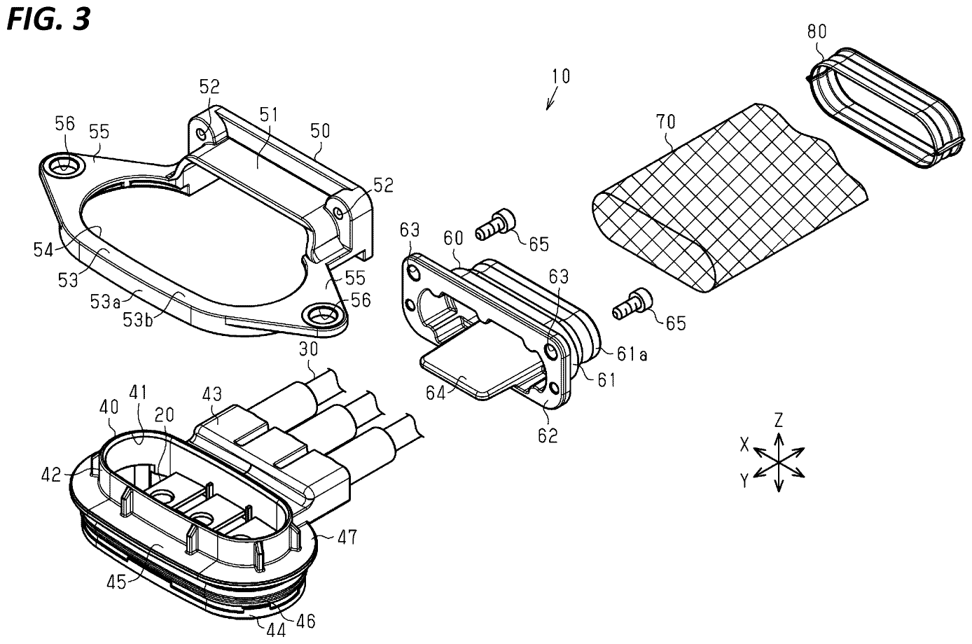

As shown in FIGS. 2A and 3, the housing 40 includes a tubular receptacle 42 and a terminal holding portion 43 projecting toward an outer peripheral side of the receptacle 42 from the receptacle 42. A resin material such as polybutylene terephthalate (PBT) can be, for example, used as a material of the housing 40.

The receptacle 42 constitutes a part of a tube portion of the housing 40. The receptacle 42 includes an opening 41 for exposing the terminal connecting portions 22 of the plurality of terminals 20 to inside. The opening 41 penetrates through the receptacle 42 in the Z-axis direction. The opening 41 has, for example, an elliptical shape long in the X-axis direction.

A tubular fitting portion 44 to be fit into the opening 101 of the enclosure 100 is provided on one end part in the Z-axis direction of the receptacle 42. The fitting portion 44 constitutes part of the tube portion of the housing 40. An annular water stop member 46 made of, for example, a resilient material such as rubber is provided on the outer peripheral surface of the fitting portion 44. The water stop member 44 seals between the fitting portion 44 and the opening 101 of the enclosure 100. The water stop member 46 is, for example, mounted in a groove 44a formed along a circumferential direction in the outer peripheral surface of the fitting portion 44.

### (Configuration of Extending Portion 47)

The housing 40 includes a flange portion 45 protruding toward the outer peripheral side of the receptacle 42 from the receptacle 42. The flange portion 45 extends, for example, along an XY plane. The flange portion 45 protrudes from a part adjacent to the fitting portion 44 in the Z-axis direction and a part except the terminal holding portion 43, out of the receptacle 42. The flange portion 45 is linked to the terminal holding portion 43 in the circumferential direction of the receptacle 42.

Note that, in a state where the vehicle installed with the device having the terminal block 10 mounted thereon is installed on a horizontal surface, an installation posture of the terminal block 10 is such that the XY plane intersects a direction of gravity. That is, with the vehicle installed on the horizontal surface, the flange portion 45 extends along a plane intersecting the direction of gravity.

The flange portion 45 and the terminal holding portion 43 constitute an extending portion 47 extending toward the outer peripheral side from the receptacle 42 constituting a part of the tube portion. The flange portion 45 and the terminal holding portion 43 are continuous in the circumferential direction of the receptacle 42. That is, the extending portion 47 composed of the flange portion 45 and the terminal holding portion 43 is provided over the entire periphery of the receptacle 42. In other words, the terminal holding portion 43 constitutes a part of the extending portion 47 in the circumferential direction and the flange portion 45 constitutes a part of the extending portion 47 other than the terminal holding portion 43. Note that the outer edge of the flange portion 45 is located further on the outer peripheral side than the outer peripheral surface of the fitting portion 44. Further, the terminal holding portion 43 extends further toward the outer peripheral side than the outer peripheral surface of the fitting portion 44.

The terminal holding portion 43 holds the plurality of terminals 20 and the plurality of wires 30. The plurality of terminals 20, the plurality of wires 30 and the housing 40 are integrated by insert molding. Each wire 30 is pulled out in one direction along the Y-axis direction from the terminal holding portion 43.

As shown in FIG. 2A, the terminal 20 includes an embedded portion 24 embedded in the terminal holding portion 43. The embedded portion 24 includes the wire connecting portion 21. The wire 30 is connected to the wire connecting portion 21, which is a part of the embedded portion 24.

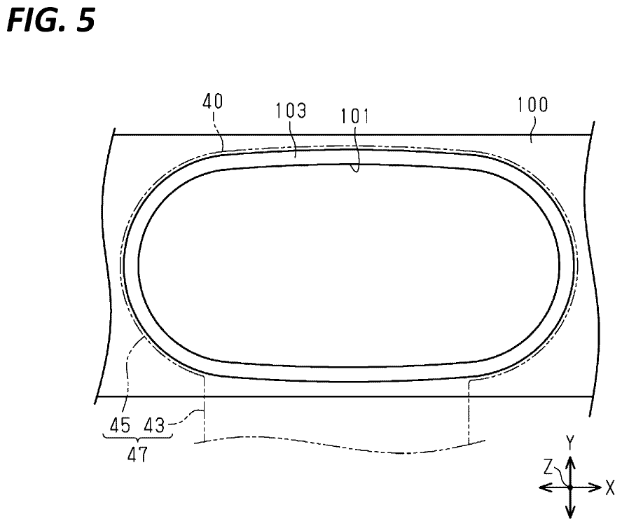

As shown in FIGS. 1 and 2A, the enclosure 100 includes an annular wall 103, for example, extending along the Z-axis direction. The inner peripheral surface of the annular wall 103 forms an outer end part of the opening 101. The annular wall 103 has an annular shape when viewed from the opening direction (Z-axis direction) of the opening 101 (see FIG. 5).

FIG. 5 is a view of the opening 101 of the enclosure 100 when viewed from the opening direction (Z-axis direction). In FIG. 5, the outer edge of the extending portion 47, i.e. the outer edges of the flange portion 45 and the terminal holding portion 43 are shown by two-dot chain line. The extending portion 47 has larger external dimensions than the opening 101 over the entire periphery of the opening 101 when viewed from the opening direction (Z-axis direction) of the opening 101. Further, the extending portion 47 of this embodiment has larger external dimensions than the outer peripheral surface of the annular wall 103 over the entire periphery of the opening 101 when viewed from the opening direction (Z-axis direction) of the opening 101.

As shown in FIG. 2A, the extending portion 47 is located on the side of the annular wall 103 in the Z-axis direction over the entire periphery of the annular wall 103. The flange portion 45 is in contact with a tip part in the Z-axis direction of the annular wall 103 or facing this tip part via a slight gap. Further, the terminal holding portion 43 is in contact with the tip part in the Z-axis direction of the annular wall 103 or facing this tip part via a slight gap.

### (Configuration of First Shield Shell 50)

The first shield shell 50 is open toward the enclosure 100 and covers the housing 40 from a side opposite to the enclosure 100. Note that the first shield shell 50 is not fixed to the housing 40. Therefore, the first shield shell 50 is provided relatively movably with respect to the housing 40. The first shield shell 50 covers at least the extending portion 47 of the housing 40.

As shown in FIG. 3, the first shield shell 50 includes a mounting portion 51 for covering a part of the terminal holding portion 43, the bracket 60 being attached to the mounting portion 51, a surrounding portion 53 surrounding the outer periphery of the receptacle 42 and two fixing portions 55 to be fixed to the enclosure 100. The mounting portion 51, the surrounding portion 53 and the fixing portions 55 are integrally provided. An iron-based or aluminum-based metal material or the like can be, for example, used as a material of the first shield shell 50. The first shield shell 50 of this embodiment is, for example, made of aluminum alloy.

The mounting portion 51 covers the terminal holding portion 43 from a side opposite to the housing 100 in the Z-axis direction. More particularly, the mounting portion 51 covers a part on the side opposite to the housing 100 in the Z-axis direction and parts on both sides in the X-axis direction, out of the terminal holding portion 43. The mounting portion 51 is gate-shaped as a whole.

Two screw holes 52, to which bolts 65 are fastened, are provided in both end parts in the X-axis direction of the mounting portion 51. The screw hole 52 penetrates through the mounting portion 51 in the Y-axis direction.

The surrounding portion 53 includes an insertion hole 54, into which the receptacle 42 is inserted. The insertion hole 54 penetrates through the surrounding portion 53 in the Z-axis direction. The insertion hole 54 has an elliptical shape long in the X-axis direction.

The surrounding portion 53 includes a peripheral wall 53a surrounding the outer peripheries of the receptacle 42 and the flange portion 45, and a top wall 53b protruding toward an inner peripheral side from the peripheral wall 53a over the entire periphery of the peripheral wall 53a.

The top wall 53b covers the outer edge of the flange portion 45 from the side opposite to the enclosure 100 in the Z-axis direction. That is, the top wall 53b and the flange portion 45 overlap when viewed from the Z-axis direction.

As shown in FIG. 2A, gaps enabling a liquid to flow are formed between the first shield shell 50 and the extending portion 47. In particular, as shown in FIG. 2B, a gap S1 enabling a liquid to flow is formed between the top wall 53b of the surrounding portion 53 and the flange portion 45 in the Z-axis direction. Further, a gap S2 enabling a liquid to flow is formed between the peripheral wall 53a of the surrounding portion 53 and the flange portion 45 in the Z-axis direction. Further, as shown in FIG. 2A, a gap enabling a liquid to flow is formed between the mounting portion 51 and the terminal holding portion 43.

As shown in FIG. 1, the fixing portion 55 includes an insertion hole 56, into which a bolt 57 is inserted. By fastening the bolts 57 inserted into the insertion holes 56 to internally threaded portions 102 provided on the enclosure 100, the first shield shell 50 is fixed to the enclosure 100.

### (Configuration of Bracket 60)

As shown in FIGS. 2A and 3, the bracket 60 covers the terminal holding portion 43 over the entire periphery. Note that the bracket 60 is not fixed to the housing 40. Therefore, the bracket 60 is provided relatively movably with respect to the housing 40.

The bracket 60 includes a tubular portion 61, into which the terminal holding portion 43 is inserted, a mounting portion 62 to be mounted into the mounting portion 51 of the first shield shell 50 and a projecting piece 64 projecting from the tubular portion 61. An iron-based or aluminum-based metal material or the like can be, for example, used as a material of the bracket 60. The bracket 60 of this embodiment is, for example, made of aluminum alloy.

The tubular portion 61 covers a part, which is adjacent in the Y-axis direction to the part covered by the mounting portion 51 of the first shield shell 50, out of the terminal holding portion 43, over an entire periphery. The tubular portion 61 has an end part 61a, on which the braided member 70 is mounted.

As shown in FIG. 3, the mounting portion 62 projects toward an outer peripheral side over an entire periphery from an end part of the tubular portion 61 on a side opposite to the end part 61a. The mounting portion 62 is provided with two insertion holes 63, into which the bolts 65 are inserted. The insertion hole 63 penetrates through the mounting portion 62 in the Y-axis direction. By fastening the bolts 65 inserted into the insertion holes 63 to the screw holes 52 of the first shield shell 50, the bracket 60 is attached to the first shield shell 50.

As shown in FIG. 2A, the projecting piece 64 projects toward the receptacle 42 in the Y-axis direction from the tubular portion 61. The projecting piece 64 is located on a side opposite to the mounting portion 51 of the first shield shell 50 across the terminal holding portion 43. A slight gap is provided in the Z-axis direction between the projecting piece 64 and the terminal holding portion 43.

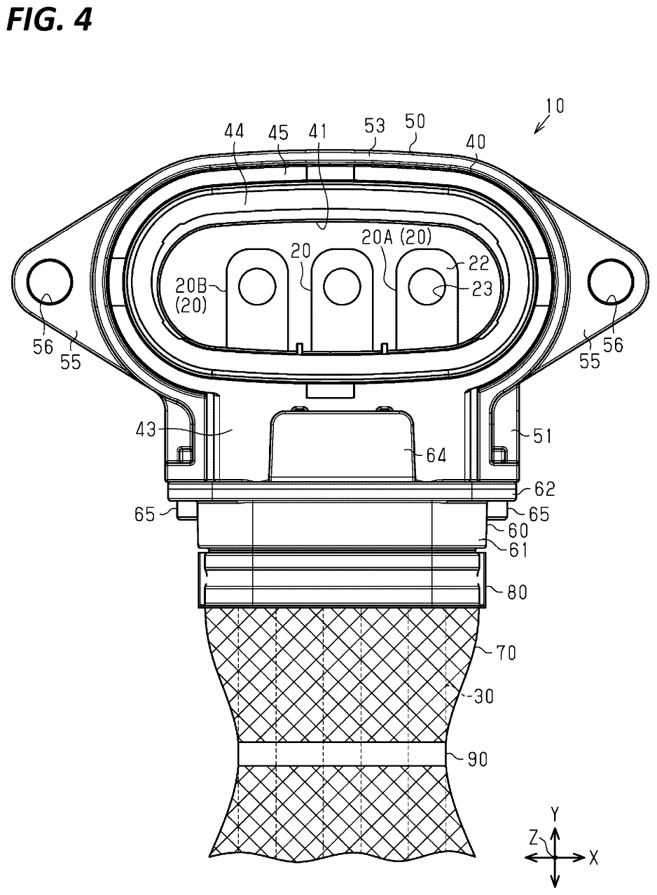

As shown in FIG. 4, the projecting piece 64 extends over each of the plurality of terminals 20 in the X-axis direction. When viewed from the Z-axis direction, the projecting piece 64 overlaps each of the plurality of terminals 20.

Out of the plurality of terminals 20, the outermost terminal 20 on one side in the X-axis direction is referred to as the terminal 20A and the outermost terminal 20 on the other side in the X-axis direction is referred to as the terminal 20B below.

One end in the X-axis direction of the projecting piece 64 extends over a part of the terminal 20A in the X-axis direction. The other end in the X-axis direction of the projecting piece 64 extends over a part of the terminal 20B in the X-axis direction.

As shown in FIG. 2A, the wire connecting portion 21 of each of the plurality of terminals 20 is located between the mounting portion 51 of the first shield shell 50 and the projecting piece 64. Therefore, each wire connecting portion 21 is covered by the mounting portion 51 and the projecting piece 64.

### (Configuration of Braided Member 70)

As shown in FIGS. 1, 2A and 3, the braided member 70 is, for example, formed by braiding electrically conductive strands into a tubular shape. A braided member formed by braiding a plurality of types of metal strands or a braided member formed by braiding metal strands and resin strands in combination can be used as the braided member 70. A copper-based or aluminum-based metal material or the like can be, for example, used as a material of the metal strands. Reinforced fibers excellent in insulation property and shear resistance such as aramid fibers can be, for example, used as the resin strands. The braided member 70 of this embodiment is formed by braiding metal strands of aluminum alloy into a tubular shape.

The braided member 70 collectively covers the plurality of wires 30 pulled out from the housing 40. One end of the braided member 70 in a length direction covers the end part 61a of the bracket 60 from an outer peripheral side.

### (Configuration of Crimp Ring 80)

The crimp ring 80 has a ring shape surrounding the outer peripheral surface of the end part 61a of the bracket 60. An iron-based, copper-based or aluminum-based metal material or the like can be, for example, used as a material of the crimp ring 80. The crimp ring 80 is made of aluminum alloy.

The crimp ring 80 fixes the braided member 70 to the outer peripheral surface of the end part 61a of the bracket 60 by being crimped to the end part 61a with the braided member 70 sandwiched between the outer peripheral surface of the end part 61a and the crimp ring 80. In this way, the braided member 70 and the bracket 60 are electrically connected.

### (Configuration of Fixing Member 90)

As shown in FIG. 1, the fixing member 90 is, for example, a tape member. The fixing member 90 has an adhesive layer on one surface in a thickness direction. The fixing member 90 is wound around the outer peripheral surface of the braided member 70 a plurality of times with the adhesive layer facing inward. The braided member 70 is pressed against the wire 30 by the fixing member 90. In this way, the braided member 70 is fixed to the wires 30.

### (Configuration of Second Shield Shell 120)

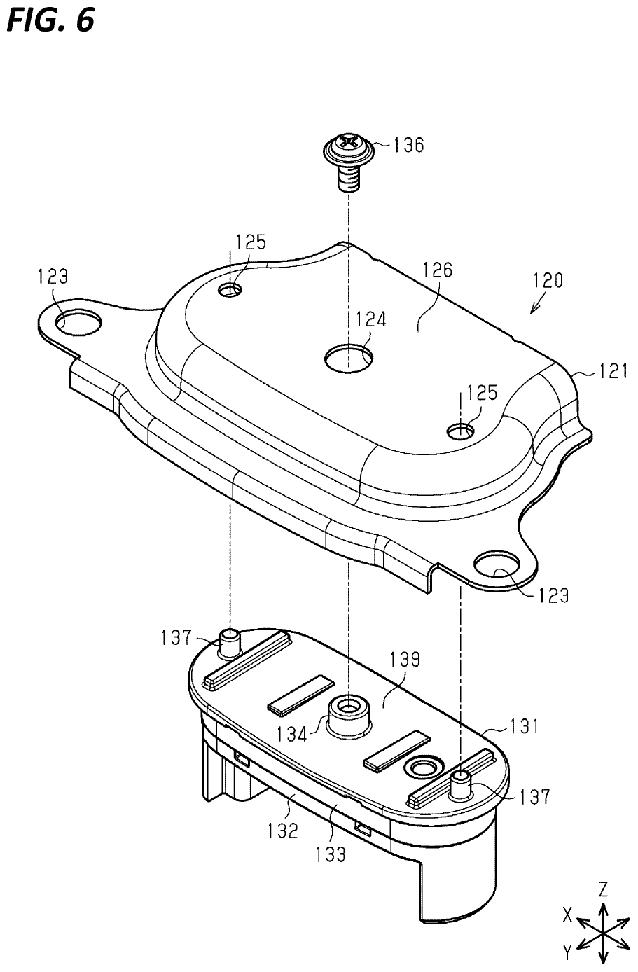

As shown in FIGS. 2A and 6, the second shield shell 120 is provided with a shell body 121 and a closing member 131 attached to the shell body 121.

The shell body 121 is, for example, made of an iron based or aluminum-based metal material. As shown in FIG. 1, the shell body 121 includes a plurality of insertion holes 123, into which bolts 122 are respectively inserted. By fastening the bolts 122 inserted into the insertion holes 123 to internally threaded portions 104 provided on the enclosure 100, the second shield shell 120 is fixed to the enclosure 100.

The closing member 131 is, for example, made of a resin material. As shown in FIG. 2A, the closing member 131 closes the opening 41 of the receptacle 42. In particular, as shown in FIGS. 2A and 6, the closing member 131 includes a fitting portion 132 to be fit into the opening 41. An annular water stop member 133 made of, for example, a resilient material such as rubber is provided on the outer peripheral surface of the fitting portion 132. The water stop member 133 seals between the fitting portion 132 and the opening 42.

The shell body 121 is formed with a first through hole 124 penetrating in the Z-axis direction and a pair of second through holes 125 penetrating in the Z-axis direction. The closing member 131 includes an internally threaded portion 134 extending in the Z-axis direction from the fitting portion 132 and to be inserted into the first through hole 124. Note that a gap is set between the outer peripheral surface of the internally threaded portion 134 and the first through hole 124 (see FIG. 2B).

A screw 136 is threadably engaged with the internally threaded portion 134. The screw 136 prevents the detachment of the closing member 131 from the shell body 121 in a state before the shell body 121 is fixed to the enclosure 100. Note that a gap is present between a seating surface of the screw 136 and a surface of the shell body 121 with the terminal block 10 assembled with the enclosure 100 (see FIG. 2B).

As shown in FIGS. 1 and 6, the closing member 131 includes a pair of positioning projections 137 projecting in the Z-axis direction from the fitting portion 132 and to be respectively inserted into the pair of second through holes 125. Gaps are set between the second through holes 125 and the positioning projections 137 inserted in the second through holes 125 (see an enlarged view in FIG. 1).

As shown in FIG. 2B, the closing member 131 includes insulation walls 138 extending in the Z-axis direction from the fitting portion 132. The insulation walls 138 are arranged between adjacent ones of the terminal connecting portions 22. The insulation wall 138 is for ensuring an insulation distance between the terminal connecting portions 22.

As shown in FIGS. 2A, 2B and 6, the shell body 121 includes an inclined portion 126. Here, in the Y-axis direction, a side where the terminal holding portion 43 of the extending portion 47 is provided is referred to as a rear side and an opposite side thereof is referred to as a front side. The inclined portion 126 is inclined to approach the housing 40 from an end part of the shell body 121 on the rear side toward the front side. Note that the first through hole 124 and the second through holes 125 are, for example, formed in the inclined portion 126. A front end part of the shell body 121 is located outward of the peripheral wall 53a of the surrounding portion 53 in the Y-axis direction.

As shown in FIGS. 2B and 6, an end surface of the closing member 131 facing the shell body 121 in the Z-axis direction is an inclined surface 139. The inclined surface 139 is inclined to approach the receptacle 42 from a rear end part toward a front end part thereof. The internally threaded portion 134 and the positioning projection 137 extend from the inclined surface 139. As shown in FIG. 2B, a gap S3 enabling a liquid to flow is formed between the inclined surface 139 and the inner side surface of the inclined portion 126 in the Z-axis direction. Further, a gap S4 enabling a liquid to flow is also formed between the shell body 121 and the housing 40.

### (Assembly Mode of Terminal Block 10)

In assembling the terminal block 10 with the enclosure 100, the fitting portion 44 of the housing 40 is first inserted into the opening 101 of the enclosure 100.

Subsequently, each terminal 20 is electrically connected to each mating terminal 110 by the bolt 111.

Subsequently, the fixing portions 55 of the first shield shell 50 are fixed to the internally threaded portions 102 of the enclosure 100 by the bolts 57. In this way, the first shield shell 50 is electrically connected and grounded to the enclosure 100. Note that the bracket 60 having the braided member 70 mounted thereon is attached to the first shield shell 50 in advance. The braided member 70 is grounded to the enclosure 100 via the bracket 60 and the first shield shell 50.

Subsequently, the second shield shell 120 is assembled. At this time, the closing member 131 is fit into the opening 41 of the receptacle 42. Further, the shell body 121 is fixed to the internally threaded portions 104 of the enclosure 100 by the bolts 122. In this way, the shell body 121 is electrically connected and grounded to the enclosure 100.

In this way, the terminal block 10 is assembled with the enclosure 100.

Functions of this embodiment are described.

When the terminal block 10 is exposed to water, the water may intrude into the inside of the shell body 121 of the second shield shell 120. Water intrusion paths into the inside of the shell body 121 include, for example, the gap between the first through hole 124 and the internally threaded portion 134 and the gaps between the second through holes 125 and the positioning projections 137.

The water having intruded into the inside of the shell body 121 through the first and second through holes 124, 125 mainly flows to the inclined surface 139 of the closing member 131. The water adhering to the inclined surface 139 mainly flows to the front side, i.e. the side opposite to the terminal holding portion 43, by the inclination of the inclined surface 139 and falls down from a front end part of the inclined surface 139 to the flange portion 45 (see a broken-line arrow in FIG. 2B). Although the water easily flows toward the front side by the inclined surface 139, the water may fall down from the inclined surface 139 toward the rear side and adhere to the terminal holding portion 43. In this way, the water adheres to the extending portion 47 including the flange portion 45 and the terminal holding portion 43.

Here, the extending portion 47 has the larger external dimensions than the opening 101 over the entire periphery of the opening 101 when viewed from the opening direction (Z-axis direction) of the opening 101. In this way, the extending portion 47 functions as eaves for covering the opening 101 over the entire periphery. Accordingly, most of the water adhering to the extending portion 47 flows to the outer peripheral side of the opening 101. For example, the water adhering to the flange portion 45 flows to the outer peripheral side of the opening 101 via the gap S2 between the flange portion 45 and the peripheral wall 53a of the surrounding portion 53. In this way, the water having intruded into the inside of the second shield shell 120 can flow to the outer surface of the enclosure 100 around the opening 101 by the extending portion 47 including the flange portion 45. Therefore, water intrusion between the opening 101 and the fitting portion 44 is suppressed by the extending portion 47.

Effects of this embodiment are described.
(1) The water stop member 46 is arranged between the outer peripheral surface of the fitting portion 44 and the inner peripheral surface of the opening 101. Since the water stop member 46 can be arranged at a deep position of the opening 101 in this way, the water exposure of the water stop member 46 can be suppressed. Further, in this embodiment, the extending portion 47 is provided over the entire periphery of the receptacle 42. With the fitting portion 44 fit in the opening 101, the extending portion 47 has the larger external dimensions than the opening 101 over the entire periphery of the opening 101 when viewed from the opening direction (Z-axis direction in this embodiment) of the opening 101. In this way, water intrusion into the opening 101 can be suitably suppressed by the extending portion 47. Therefore, the water exposure of the water stop member 46 can be further suppressed by the extending portion 47.

Further, by suppressing water intrusion between the opening 101 and the fitting portion 44 by the extending portion 47 of the housing 40, it is not necessary to prepare water stop structures in the first shield shell 50 and the second shield shell 120 for covering the extending portion 47. That result can contribute to simplifying the structures of the first shield shell 50 and the second shield shell 120.

Further, since the first shield shell 50 is configured to cover the extending portion 47, the housing 40 can be prevented from being erroneously fit into the opening 101. That is, if the fitting portion 44 of the housing 40 is not fit to a proper position in the opening 101, the first shield shell 50 interferes with the extending portion 47 when the first shield shell 50 is assembled with the enclosure 100. Thus, a worker easily notices erroneous assembly.
(2) The extending portion 47 is configured to include the terminal holding portion 43 for holding the terminals 20 in a circumferential part. The terminal 20 includes the terminal connecting portion 22 projecting toward the inner peripheral side of the receptacle 42 from the inner peripheral surface of the receptacle 42 and the embedded portion 24 embedded in the terminal holding portion 43. The wire 30 is connected to the embedded portion 24 and pulled out to outside from the inside of the housing 40. According to this configuration, the terminal holding portion 43 for holding the embedded portions 24 of the terminals 20 constitutes a part of the extending portion 47. That is, the water exposure of the water stop member 46 can be suppressed by the extending portion 47 including the terminal holding portion 43.
(3) The gaps S1, S2 enabling a liquid to flow are formed between the first shield shell 50 and the extending portion 47. According to this configuration, water can be suppressed from staying between the extending portion 47 and the first shield shell 50 by the gaps S1, S2 between the extending portion 47 and the first shield shell 50. As a result, the water exposure of the water stop member 46 can be more suitably suppressed.
(4) The terminal block 10 is provided with the second shield shell 120 for covering the housing 40 and the first shield shell 50. The second shield shell 120 includes the shell body 121 made of metal for covering the housing 40 and the first shield shell 50, and the closing member 131 provided on the side of the shell body 121 toward the housing 40 for closing the one end part of the receptacle 42. The gap S3 enabling a liquid to flow is formed between the shell body 121 and the closing member 131. Further, the gap S4 enabling a liquid to flow is formed between the shell body 121 and the housing 40. According to this configuration, since the housing 40 is easily exposed to water due to the presence of the gaps S3, S4, for example, when water intrudes into the inside of the shell body 121, a water exposure suppressing effect for the water stop member 46 by the extending portion 47 can be obtained more notably.
(5) If the side of the extending portion 47 where the terminal holding portion 43 is provided is the rear side and the opposite side thereof is the front side, the shell body 121 includes the inclined portion 126 inclined to approach the housing 40 from the end part on the rear side toward the front side. According to this configuration, water adhering to the outer surface of the shell body 121 easily flows to the front side, i.e. the side opposite to the terminal holding portion 43, by the inclination of the inclined portion 126. In this way, the flow of the water adhering to the outer surface of the shell body 121 toward the terminal holding portion 43 can be suppressed.

### <Modifications>

This embodiment can be modified and carried out as follows. This embodiment and the following modifications can be carried out in combination without technically contradicting each other.
The fixing member 90 is not limited to the tape member and may be, for example, a zip tie for tightening the braided member 70 to the wires 30.
The fixing member 90 can be omitted from the terminal block 10.
The terminal block 10 may be provided with a plurality of the braided members 70 for individually covering the outer peripheries of the plurality of wires 30. In this case, the fixing member 90 may collectively fix the plurality of braided members 70 to the plurality of wires 30 or may individually fix the plurality of braided members 70 to the plurality of wires 30.
The braided member 70 may partially cover the outer peripheries of the wires 30. The braided member 70 may be, for example, sheet-like and cover the wires 30 from the side opposite to the enclosure 100.
The braided member 70 can be omitted from the terminal block 10. In this case, the plurality of wires 30 may be, for example, shielded cables having an electromagnetic shielding performance themselves.
Although the receptacle 42 of the above embodiment includes the opening 41 penetrating in the Z-axis direction, the receptacle 42 may include the opening 41 open only in the fitting portion 44. In this case, pin-shaped male terminals having tips extending in the opening direction of the fitting portion 44 from the inside of the receptacle 42 can be adopted as the terminals 20. Further, female terminals, into which the male terminals are inserted, can be adopted as the mating terminals 110.
The projecting piece 64 may extend over the terminals 20A, 20B entirely in the X-axis direction.
The projecting piece 64 may extend over only one terminal 20 in the X-axis direction.
In the enclosure 100 of the above embodiment, the annular wall 103 may be omitted.
In the shown embodiment, the receptacle 42 and the fitting portion 44 may be called a first tube portion and a second tube portion, which may be coaxial with each other. In the shown embodiment, the opening direction (Z-axis direction) of the opening 101 may be called a mounting direction of the terminal block 10 into the opening or a center axis or an axial direction of the receptacle 42 and/or the fitting portion 44. With the terminal block 10 fixed to the enclosure 100, the first tube portion (receptacle 42) of the terminal block 10 can have an opening end edge (upper edge in FIG. 1) located outside the enclosure 100 and the second tube portion (fitting portion 44) of the terminal block 10 can have an opening end edge (lower edge in FIG. 1) located inside the enclosure 100. The terminal 20 may be located between the opening end edge (upper edge in FIG. 1) of the first tube portion (receptacle 42) and the opening edge part (lower edge in FIG. 1) of the second tube portion (fitting portion 44), and may not project in the axial direction of the first and second tube portions from either one of the opening end edge of the first tube portion and the opening end edge of the second tube portion.
The Y-axis direction of the shown embodiment may be called a radially outward direction or a wire pull-out direction with respect to the receptacle 42 and/or the fitting portion 44, and/or may be called a radially inward direction or a terminal projecting direction with respect to the receptacle 42 and/or the fitting portion 44.
In the shown embodiment, the opening 101 provided in the enclosure 100 of the device may be called a terminal block receiving hole. As shown in FIG. 1, the terminal block 10 according to the non-limiting embodiment of the present disclosure may be configured to be fit later into the terminal block receiving hole (opening 101) provided in the enclosure 100 of the device and/or to be removable from the terminal block receiving hole (opening 101). The second tube portion (fitting portion 44) of the terminal block 10 may be configured to be fit into the terminal block receiving hole (opening 101) provided in the enclosure 100 of the device, for example, by linear frictional contact in a mounting direction Z without being screwed or rotated.
The embodiment and the modifications disclosed this time are illustrative in all aspects and the present invention is not limited to these illustrations. That is, the scope of the present invention is represented by claims and intended to include all changes in the scope of claims and in the meaning and scope of equivalents.

### LIST OF REFERENCE NUMERALS

10 terminal block
20 terminal
20A terminal
20B terminal
21 wire connecting portion
22 terminal connecting portion
23 insertion hole
24 embedded portion
30 wire
31 core wire
32 insulation coating
40 housing (resin molded portion)
41 opening
42 receptacle (part of tube portion)
43 terminal holding portion
44 fitting portion (part of tube portion)
44a groove
45 flange portion
46 water stop member
47 extending portion
50 first shield shell
51 mounting portion
52 screw hole
53 surrounding portion
53a peripheral wall
53b top wall
54 insertion hole
55 fixing portion
56 insertion hole
57 bolt
60 bracket
61 tubular portion
61a end part
62 mounting portion
63 insertion hole
64 projecting piece
65 bolt
70 braided member
80 crimp ring
90 fixing member
100 enclosure
101 opening
102 internally threaded portion
103 annular wall
104 internally threaded portion
110 mating terminal
111 bolt
120 second shield shell
121 shell body
122 bolt
123 insertion hole
124 first through hole
125 second through hole
126 inclined portion
131 closing member
132 fitting portion
133 water stop member
134 internally threaded portion
136 screw
137 positioning projection
138 insulation wall
139 inclined surface
S1 S2, S3, S4 gap

1. A terminal block to be mounted into an opening provided in an enclosure of a device, comprising:
a resin molded portion made of resin, the resin molded portion including a tube portion to be fit into the opening and an extending portion extending toward an outer peripheral side from the tube portion;
a terminal projecting toward an inner peripheral side of the tube portion from an inner peripheral surface of the tube portion;
a wire connected to the terminal;
a water stop member arranged between an outer peripheral surface of the tube portion and an inner peripheral surface of the opening to stop water therebetween; and
a first shield shell made of metal, the first shield shell covering the extending portion,
the extending portion being provided over an entire periphery of the tube portion, and
the extending portion having larger external dimensions than the opening over an entire periphery of the opening when viewed from an opening direction of the opening with the tube portion fit in the opening.

2. The terminal block of claim 1, wherein:
the extending portion includes a terminal holding portion for holding the terminal in a circumferential part,
the terminal includes a terminal connecting portion projecting toward the inner peripheral side of the tube portion from the inner peripheral surface of the tube portion and an embedded portion embedded in the terminal holding portion, and
the wire is connected to the embedded portion and pulled out to outside from inside of the resin molded portion.

3. The terminal block of claim 1, wherein a gap enabling a liquid to flow is formed between the first shield shell and the extending portion.

4. The terminal block of claim 2, comprising a second shield shell for covering the resin molded portion and the first shield shell, wherein:
the second shield shell includes a shell body made of metal, the shell body covering the resin molded portion and the first shield shell, and a closing member provided on a side of the shell body toward the resin molded portion, the closing member closing one end part of the tube portion, and
gaps enabling a liquid to flow are respectively formed between the shell body and the closing member and between the shell body and the resin molded portion.

5. The terminal block of claim 4, wherein the shell body includes an inclined portion inclined to approach the resin molded portion from an end part on a rear side toward a front side when a side of the extending portion where the terminal holding portion is provided is the rear side and an opposite side thereof is the front side.
